(19) United States
(12) Patent Application Publication
(10) Pub. No.: US 2014/0060069 A1
(43) Pub. Date: Mar. 6, 2014

(54) COMBUSTOR INCLUDING COMBUSTION NOZZLE AND AN ASSOCIATED METHOD THEREOF

(71) Applicants: Uyigue Omoma Idahosa, North Greengush, NY (US); Anthony Robert Brand, Tribes Hill, NY (US); Hasan Karim, Greenville, SC (US); Michael John Hughes, Pittsburgh, PA (US)

(72) Inventors: Uyigue Omoma Idahosa, North Greengush, NY (US); Anthony Robert Brand, Tribes Hill, NY (US); Hasan Karim, Greenville, SC (US); Michael John Hughes, Pittsburgh, PA (US)

(73) Assignee: GENERAL ELECTRIC COMPANY, Schenectady, NY (US)

(21) Appl. No.: 13/600,833

(22) Filed: Aug. 31, 2012

(51) Int. Cl. F02C 7/22; F23R 3/28

(52) U.S. Cl. 60/776; 60/737

(57) ABSTRACT

A combustor including a combustion nozzle. The combustion nozzle includes a mixing section and an exit section. The mixing section includes an air inlet, and a fuel inlet. The exit section includes a plurality of jets on an exit surface. The combustor further includes a combustion zone, including a combustion liner, disposed downstream and in fluidic communication with the combustion nozzle. The combustor is configured wherein a, NOx emission of the combustor is related to 1/R, where R is a Reynolds number ratio of a jet of the plurality of jets to the combustion liner. A method for achieving NOx reduction in a combustion nozzle.

### BACKGROUND

The disclosure relates generally to combustors, and more specifically, to a combustion nozzle for injecting an air-fuel mixture into a combustion zone within a combustor.

A combustor is a component or area of an engine where combustion takes place. In a gas turbine engine, for example, a compressor feeds high pressure air to the combustor or combustion chamber. The combustor then heats the air along with a fuel at a constant pressure. After combustion, the generated exhaust gases are fed from the combustor to the turbine via the nozzle guide vanes. Such an engine employed in a gas turbine plant or a combined cycle plant, for example, is operated to achieve higher operational efficiency under higher temperature and higher pressure conditions, and tends to increase emissions (for example, CO, NOx) in an exhaust gas stream. Although various factors for generation of emissions are known, the dominant ones are flame temperature and size in a combustor.

Experimental evidence demonstrates that increasing turbulence activities in the combustion zone, and more particularly in a combustion liner, may lead to lower NOx emissions. The Reynolds number of a combustion nozzle jet is well correlated with turbulence, with higher turbulence levels as the Reynolds number of a jet is increased. One method of increasing turbulence is by directly increasing the jet velocity. However, this method is associated with an increase in nozzle pressure drop. Furthermore, the overall gas turbine efficiency is penalized with higher combustor pressure drops.

In light of the above, it is desired to provide an improved combustor, including an improved combustion nozzle and associated method of use that ensures lower levels of NOx emissions, along with maintaining flame stability without incurring a pressure drop penalty from increasing the nozzle velocity.

### BRIEF DESCRIPTION

In accordance with one exemplary embodiment of the present disclosure, a combustor including a combustor nozzle is disclosed. The combustor includes a combustion housing; a combustion nozzle disposed within the combustion housing, the combustion nozzle comprising: a mixing section comprising an air inlet and a fuel inlet; and an exit section in fluidic communication with the mixing section, the exit section comprising a plurality of jets formed on an exit surface; and a combustion zone, including a combustion liner, disposed downstream and in fluidic communication with the combustion nozzle, wherein a, NOx emission of the combustor is related to 1/R, where R is a Reynolds number ratio of a jet of the plurality of jets to the combustion liner.

In accordance with another exemplary embodiment of the present disclosure, a gas turbine is disclosed. The gas turbine includes an air compressor; a combustor coupled to the compressor, the combustor comprising: a combustion housing; and a combustion nozzle disposed within the combustion housing, the combustion nozzle comprising: a mixing section comprising an air inlet, and a fuel inlet; and an exit section comprising a plurality of jets on an exit surface; and a combustion zone, including a combustion liner, disposed downstream and in fluidic communication with the combustion nozzle; and a turbine coupled to the combustor, wherein a NOx emission of the combustor is related to 1/R, where R is a Reynolds number ratio of each of the plurality of jets to the combustion liner.

In accordance with another exemplary embodiment of the present disclosure, a method for achieving NOx reduction in a combustion nozzle is disclosed. The method includes setting a combustion liner velocity (V_{L}) based on machine sizing requirements; setting a combustion liner diameter (d_{L}) based on machine sizing requirements; selecting one of a jet velocity (V_{J}) or a jet diameter (d_{J}) based on desired pressure drop across an exit surface of the combustion nozzle; calculating the number of jets (n) at the exit surface of the combustion nozzle; calculating the other of a jet diameter (dⱼ) or a jet velocity (V_{J}) of each jet at the exit surface of the combustion nozzle; and calculating an inverse of the global strain rate to determine if k criteria is achieved.

Other objects and advantages of the present disclosure will become apparent upon reading the following detailed description and the appended claims with reference to the accompanying drawings.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical representation of a gas turbine engine having an exemplary combustor in accordance with an exemplary embodiment;

FIG. 2 is a diagrammatical representation of a combustor having an exemplary combustion nozzle in accordance with an exemplary embodiment;

FIG. 3 is a diagrammatical representation of a portion of the combustor of FIG. 2 in accordance with an exemplary embodiment;

FIG. 4 is a diagrammatical representation of an exit section of a combustion nozzle in accordance with an exemplary embodiment;

FIG. 5 is a is a schematic block diagram of a method in accordance with an exemplary embodiment

FIG. 6 illustrates comparatively NOx levels of a known combustion nozzle and a combustion nozzle including a lower jet velocity and pressure, in accordance with an exemplary embodiment; and

FIG. 7 illustrates comparatively NOx levels of a known combustion nozzle and a combustion nozzle including a plurality of larger jets for reduced jet velocity, in accordance with an exemplary embodiment.

### DETAILED DESCRIPTION

In accordance with the embodiments of the present disclosure, a combustor including a combustion nozzle having a plurality of sized jets to minimize NOx emissions and associated method is disclosed. The exemplary combustion nozzle and the associated method achieve high turbulence intensity levels at lower jet velocities (and pressure drop). By maximizing the ratio of the turbulence levels between jet flames and the combustion chamber, a mixing gradient to manipulate the temperatures in the combustion zone can be controlled. Specifically, the transport of products into the combustion zone is amplified at higher turbulence intensities. In addition, heat transfer rates to and from the combustion zone can be controlled. This serves to locally lower flame temperatures in the reaction zone. Overall a gain in turbine efficiency is achieved from operating at higher flame temperature and lower NOx emissions may be simultaneously achieved at these increased temperatures. Accordingly, disclosed is a combustor including a combustion nozzle and method for sizing jet flames for low NOx emissions and low pressure drops. By maximizing the ratio of the Reynolds number of the combustion jets at an exit surface of the nozzle to the combustion liner, the jet velocity can be decreased while the turbulence levels necessary for reducing NOx are lowered.

The exemplary combustor includes a combustion nozzle including a mixing section having an air inlet, and a fuel inlet. The nozzle further includes an exit section having a plurality of jets formed in a pattern on an exit surface and sized as disclosed herein. The combustor further includes a combustion zone disposed downstream of the combustion nozzle and having a combustion liner disposed therein. During operation, NOx production is related to 1/R, where R is the ratio of the Reynolds number of the jets to the combustion liner. Increasing the Reynolds number ratio, results in lower NOx emissions by increasing turbulent mixing of products into the flame zone. In accordance with a specific embodiment of the prevent disclosure, a gas turbine having the exemplary combustor, including the combustion nozzle including an exit section having a plurality of jets formed in a pattern on an exit surface and sized as disclosed herein, is taught. In accordance with certain other embodiments, a method associated with the combustor and sizing of the combustion nozzle jets is disclosed. The novel combustion nozzle includes a jet diameter (dⱼ) and a jet count (nⱼ) that are sized for low NOx emission, while reducing nozzle pressure drop (efficiency gain) from operating at lower jet velocity (Vⱼ).

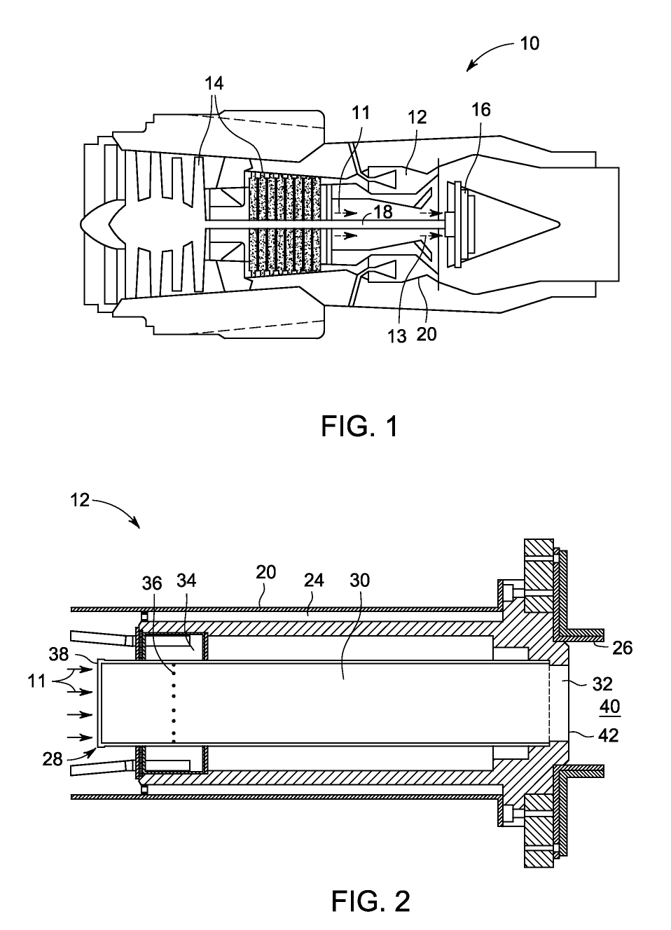

Turning now to drawings and referring first to FIG. 1, a gas turbine 10 having a low emission combustor 12 is illustrated. The gas turbine 10 includes a compressor 14 configured to compress ambient air. The combustor 12 is in flow communication with the compressor 14 and is configured to receive compressed air 11 from the compressor 14 and to combust a fuel stream to generate a combustor exit gas stream 13. In the illustrated embodiment, the combustor 12 includes a combustion housing 20 defining a combustion area. In one embodiment, the combustor 12 includes a can combustor. In an alternate embodiment, the combustor 12 includes a can-annular combustor or a purely annular combustor. In addition, the gas turbine 10 includes a turbine 16 located downstream of the combustor 12. The turbine 16 is configured to expand the combustor exit gas stream 13 to drive an external load. In the illustrated embodiment, the compressor 14 is driven by the power generated by the turbine 16 via a shaft 18.

The combustor 12 includes a combustion nozzle for receiving compressed air 11 and the fuel stream, mix the air 11 and the fuel stream to generate an air-fuel mixture, and inject the air-fuel mixture to a combustion zone. The combustion nozzle is explained in greater detail with reference to subsequent figures.

Referring to FIG. 2, the combustor 12 in accordance with the aspects of FIG. 1 is illustrated. The exemplary combustor 12 includes the combustion housing 20 defining a combustion chamber 24. A cover assembly (not shown) may be provided on one end of the combustion housing 22. A combustion liner 26 is disposed within the combustion housing 22. In an embodiment, the combustion liner 26 may be provided with a plurality of dilution holes (not shown).

A combustion nozzle 28 is disposed within the combustion chamber 24. The exemplary combustion nozzle 28 includes a mixing section 30 and an exit section 32. The combustor 12 further includes a fuel plenum 34 for supplying a fuel to the combustion chamber 24. The fuel enters the combustion nozzle 28 via one or more fuel inlet holes 36 provided in the mixing section 30. The mixing section 30 also has an air inlet 38 for receiving the air stream 11 from the compressor.

In certain embodiments, the fuel may include hydrocarbons, natural gas, or high hydrogen gas, or hydrogen, or biogas, or carbon monoxide, or syngas, or inert gas, or water vapor, or oxidizers along with predetermined amount of diluents. Diluents may include nitrogen, carbon dioxide, water, steam, or the like.

The mixing section 30 of the combustion nozzle 28 is configured to mix air 11 and the fuel and generate an air-fuel mixture. The exit section 32 is configured to receive the air-fuel mixture and inject the air-fuel mixture to a combustion zone 40 of the combustion chamber 24. The exit section 32 is configured to generate turbulent flow of the air-fuel mixture in the combustion zone 40 of the combustor 12. The exit section 32 includes a plurality of jets formed on an exit surface 42 and sized accordingly to provide for the transport of products into the combustion zone at higher turbulence intensities. The exit surface 42 with the plurality of jets is explained in greater detail with reference to subsequent figures.

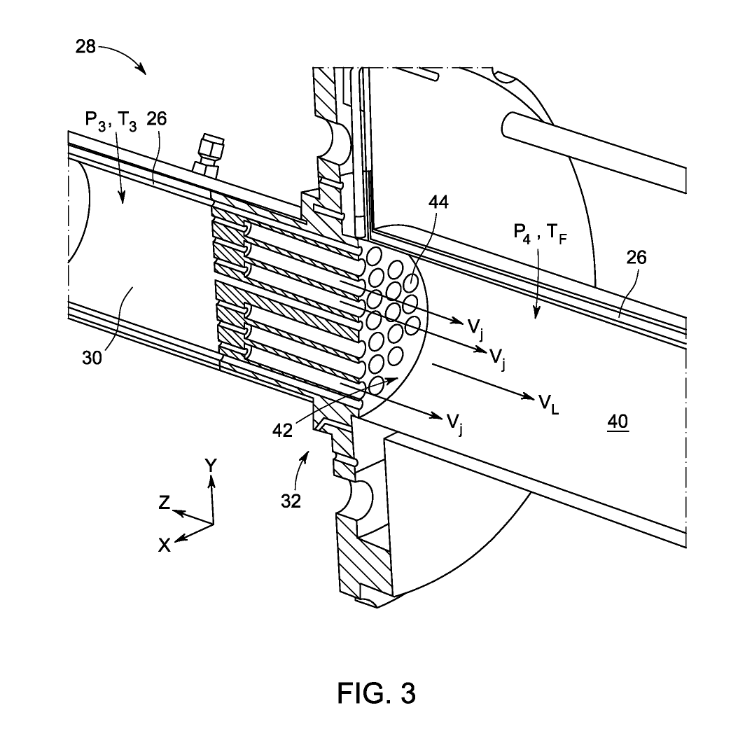

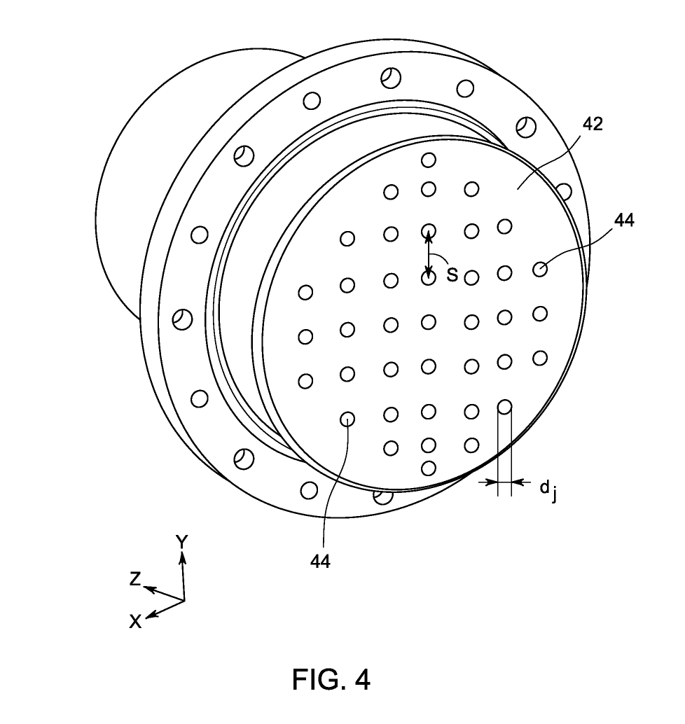

Referring to FIGS. 3 and 4, illustrated is the exit surface 42 having a plurality of jets 44 formed therein. In accordance with the embodiments of the present disclosure, the plurality of jets 44 are spaced so to occupy a large area of the exit surface 42. The plurality of jets 44 are spaced in such a way that a spacing between two mutually adjacent jets among the plurality of jets 44 is representative of a distance extending from a center of one jet to another corresponding center of other jet among the mutually adjacent jets 44. As best illustrated in FIG. 4, in the illustrated embodiment, the spacing between two mutually adjacent jets is represented by “s”, and diameter of each jet is represented by “dⱼ”. The plurality of jets 44 may be arranged in different patterns. Aspects of the nozzle jets 44 described herein are also applicable to non-circular nozzles.

Referring again to FIG. 3, as illustrated unburned reactants, typically an air and fuel mixture is at a pressure (P₃) and having a temperature (T₃). Combustion products are noted at a flame temperature (T_{F}) and pressure (P₄). The jet velocity (Vⱼ) is computed from the unburned reactant conditions (P₃, T₃). The combustion liner velocity (V_{L}) is computed at the combustion zone conditions (P₄, T_{F}).

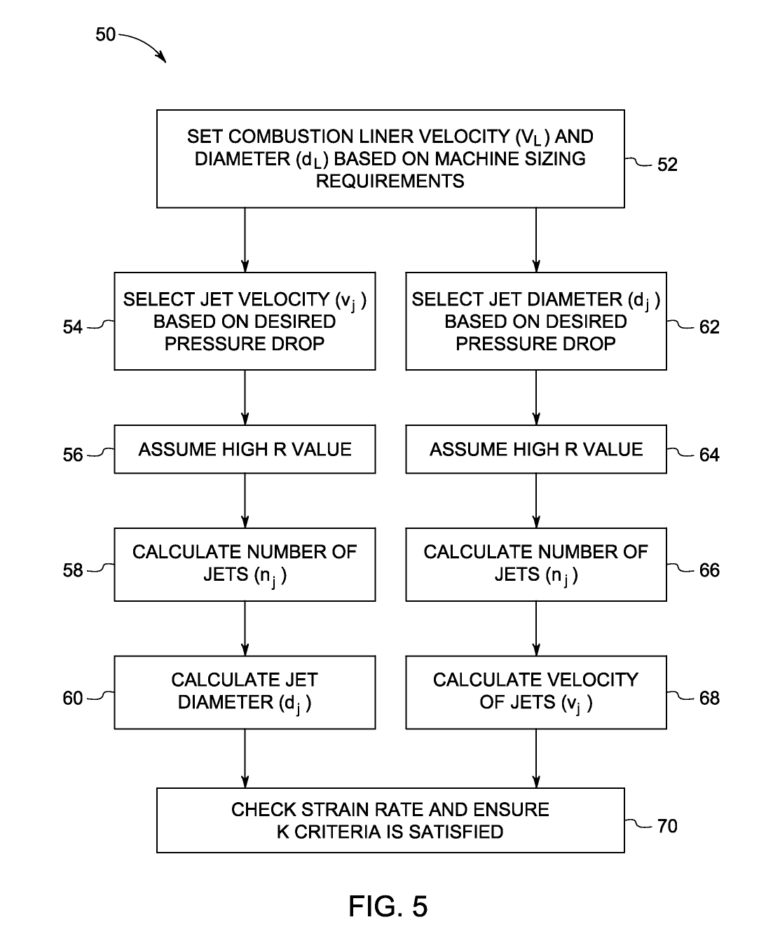

In accordance with the embodiments of the present disclosure, each of the plurality of jets 44 is sized to provide for the transport of products into the combustion zone at higher turbulence intensities, thereby providing lower NOx emissions. More particularly, wherein a NOx emission of the combustor is related to 1/R, where R is a Reynolds number ratio of each of the plurality of jets 44 to the combustion liner 26. Referring now to FIG. 5, in an embodiment, a method 50 for achieving NOx reduction in jets stabilized flames initially includes, setting the combustion liner velocity (V_{L}) and combustor line diameter (d_{L}) based on machine sizing requirements, flows etc. at a step 52. Next, in an embodiment of the method as illustrated on the left hand side in the method step diagram, at a step 54, the jet velocity (V_{J}) is selected based on desired pressure drop. The lower DP/P, the greater the efficiency gain. In an embodiment, DP/P is equal to 100*[(P₃−P₄)/P₃]. A high value is assumed for the Reynolds Number Ratio (R), at step 56. The number of jets (nⱼ) is next calculated at step 58 based on the targeted Reynolds number ratio. The diameter of each jet (dⱼ) is calculated at step 60. In an alternate embodiment of the method, the steps are reversed and initially at a step 54, the jet diameter (d_{J}) is selected based on desired jet sizes in step 62. A high value is assumed for the Reynolds Number Ratio (R), at step 64. The number of jets (n_{J}) is next calculated at step 66 based on the assumed Reynolds number ratio. The velocity of each jet (Vⱼ) and the nozzle pressure drop is calculated at step 68. Jet diameters (d_{J}) are then iteratively selected if needed to obtain acceptable nozzle pressure drops. Finally, irrespective of ordering of the previous steps, the strain rate, and more specifically, an inverse of the global strain rate, is checked to ensure k criteria is satisfied, at step 70. It should be understood that Reynolds number ratio of each the plurality of jets on the face does not have to be the equal, i.e. different size jets with different R values on the face. More particularly, not all jet, of the plurality of jets, have the same Reynolds number ratio.

To provide for proper sizing of the jets 44, the Reynolds number is calculated based on the formula:

$$R = \frac{{Re}_{j}}{{Re}_{L}} = \frac{ρ ( {P}_{3} , {T}_{3} ) {V}_{j} {d}_{j} / μ ( {T}_{3} )}{ρ ( {P}_{4} , {T}_{FLAME} ) {V}_{L} {d}_{L} / μ ( {T}_{FLAME} )}$$

where Reⱼ is the Reynolds number of a jet 44 and Re_{L} is the Reynolds number of the combustion liner 26.

During calculations, a high R value (>1.7) is assumed. In an embodiment, a recommended value is R=1.8. The higher the Reynolds number, the lower the NOx emission. In an embodiment, the following parameters for the Reynolds number ratios may be provided: R=1.3-1.5: good, R=1.5-1.7: better and R>1.7: best.

The number of jets 44 is calculated based on the formula:

$$R = \frac{{Re}_{j}}{{Re}_{L}} = {α [ \frac{{V}_{j}}{{V}_{L}} ]}^{1 / 2} ( \frac{1}{\sqrt{{n}_{j}}} ) = β \frac{{d}_{L}}{{d}_{j}} ( \frac{1}{{n}_{j}} )$$

where R is the ratio of the Reynolds number of a jet of the plurality of jets (Reⱼ) to the Reynolds number of the combustion liner (Re_{L}), Vⱼ is equal to a velocity of a jet of the plurality of jets and V_{L} is equal to a velocity of the combustion liner.

The diameter of jets 44 (dⱼ) may be calculated based on the formula:

$${d}_{j} = {[ \frac{4 \dot{m}}{πρ ( {P}_{3} , {T}_{3} ) {V}_{j} {n}_{j}} ]}^{1 / 2}$$

where m=unburned combined reactant mass flow rates of fuel and oxidizer, P3=unburned reactant pressure, T3=unburned reactant temperature (or air reheat temperature alternatively).

The diameter of the combustion liner 26 (d_{L}) may be calculated based on the formula:

$${d}_{L} = {[ \frac{4 \dot{m}}{πρ ( {P}_{4} , {T}_{FLAME} ) {V}_{L}} ]}^{1 / 2}$$

where m=unburned combined reactant mass flow rates of fuel and oxidizer, and T_{flame}=the flame temperature.

The inverse of the global strain rate may be checked to and ensure k criteria is satisfied based on the formula:

$$K ( s ) = \frac{1000 {d}_{j}}{{V}_{j}}$$

The calculated NOx emission may be calculated based on the relationship:

$$NOx \sim fcn ( \frac{1}{R } , K )$$

where κ is a computed inverse of the global strain rate.

The disclosed method and formulas for calculating the jet parameters have been experimentally determined to be valid for k<0.15.

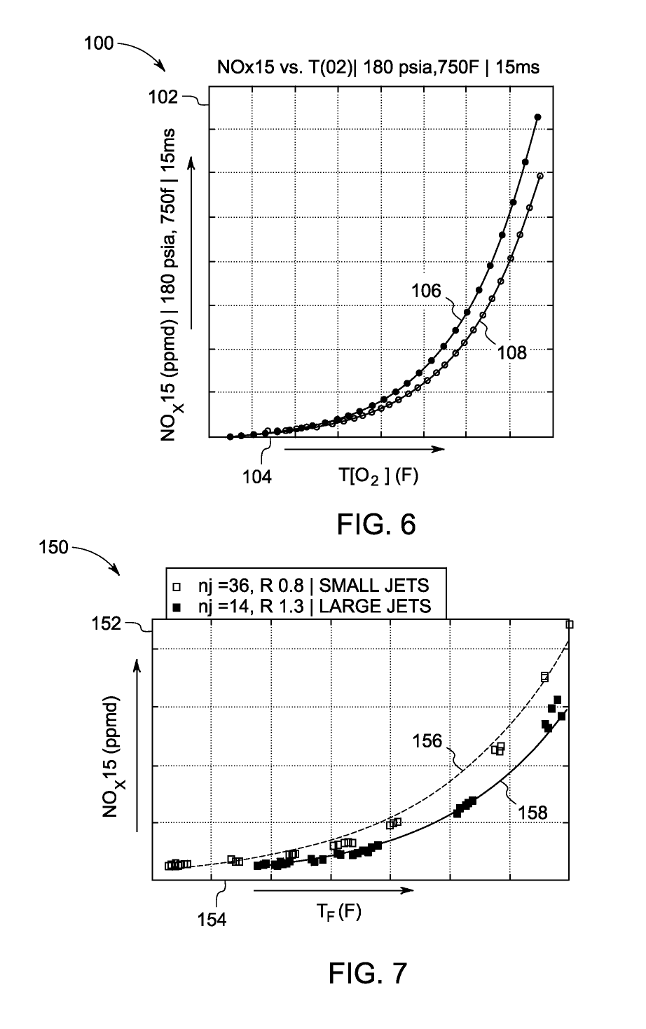

Referring now to FIG. 6, illustrated in an exemplary graphical representation, generally referenced 100, are comparative NOx levels of a known combustion nozzle and a combustion nozzle including a lower jet velocity and pressure, in accordance with an exemplary embodiment. More specifically, graph 100 illustrates NOx levels (plotted in axis 102) with the temperature profile (plotted in axis 104) of a known combustion nozzle and a novel combustion nozzle, in accordance with an embodiment described herein. More particularly, NOx levels of a known combustion nozzle (shown by plotted points/line 106), illustrate as the flame temperature increases, the NOx emissions increase. In an embodiment, the known combustion nozzle is configured having 36 jets at an exit surface, a jet velocity (V_{J}) of 220 fps, Reynolds number of 1.7, strain rate of 0.036 and 6.4% DP/P. Comparatively, NOx levels of a novel combustion nozzle configured as disclosed herein (shown by plotted points/line 108), illustrates like the known combustion nozzle, as the flame temperature increases, the NOx emissions increase. The novel combustion nozzle configured having larger jets, with a total of 16 jets at an exit surface, a lower jet velocity (V_{J}) of 150 fps, Reynolds number of 2.1, strain rate of 0.096 and 3.2% DP/P. As illustrated, substantially the same NOx emissions are evidenced in the novel combustion nozzle having a lower jet velocity and pressure drop. No penalty in NOx is observed at the lower jet velocity.

Referring now to FIG. 7, illustrated in an exemplary graphical representation, generally referenced 150, are comparative NOx levels of a known combustion nozzle and a combustion nozzle including a plurality of larger jets for reduced jet velocity, in accordance with an exemplary embodiment. More specifically, graph 150 illustrates NOx levels (plotted in axis 152) with the temperature profile (plotted in axis 154) of a known combustion nozzle and a novel combustion novel, in accordance with an embodiment described herein. More particularly, NOx levels of a known combustion nozzle (shown by plotted points/line 156), illustrate as the flame temperature increases, the NOx emissions increase. The known combustion nozzle configured having 36 jets at an exit surface, each jet having a jet diameter (dⱼ) of 0.190 in, a jet velocity (V_{J}) of 220 fps, a Reynolds number ratio (R) of 0.8, and a liner velocity (V_{L}) of 95 fps. Comparatively, NOx levels of a novel combustion nozzle configured as disclosed herein (shown by plotted points/line 158), illustrates like the known combustion nozzle, as the flame temperature increases, the NOx emissions increase. The novel combustion nozzle configured having larger jets, with a total of 14 jets at an exit surface, a Reynolds number ratio (R) of 1.3 and a jet velocity (V_{J}) of 220 fps and a liner velocity (V_{L}) of 95 fps, both of which are equal to that of the known combustion nozzle. As illustrated, lower NOx emissions are evidenced in the novel combustion nozzle having a fixed jet velocity but fewer jets and higher R in comparison to the known nozzle. The Re_{J}/Re_{L} method is used to yield a lower jet count (cost implications) and lower NOx emission. No penalty in NOx is observed at the lower jet count.

In accordance with the embodiments discussed above, achieving low NOx emissions from a gas turbine may be driven by optimal sizing of an optimal number of jets of the nozzle to increase turbulence in the flame zone. The optimal sizing of the jets is based on increasing the Reynolds number and leads to lower NOx emissions by increasing the turbulent mixing of combustion products into the flame zone essentially dilution the combustion reactions. A second mechanism is the manipulation of bulk heat transfer rates to and from the reaction zone. For a fixed velocity ratio (Vj/VL), fewer jets may be sized using this method leading to overall cost savings. Embodiments of the present disclosure provide a means to size jet diameters and velocity distributions for combustors with jet (shear-stabilized) flames. By enabling lower emissions at lower pressure drops, simultaneous gains in NOx compliance and efficiency gains from lower nozzle pressure drop/high flame temperatures are enabled. The lower NOx emissions, in conjunction with reducing the pressure drop across the combustion nozzle, enables improved operation of the gas turbine.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A combustor, comprising:
a combustion housing;
a combustion nozzle disposed within the combustion housing, the combustion nozzle comprising:
a mixing section comprising an air inlet and a fuel inlet; and
an exit section in fluidic communication with the mixing section, the exit section comprising a plurality of jets formed on an exit surface; and
a combustion zone, including a combustion liner, disposed downstream and in fluidic communication with the combustion nozzle,
wherein a, NOx emission of the combustor is related to 1/R, where R is a Reynolds number ratio of a jet of the plurality of jets to the combustion liner.

2. The combustor of claim 1, wherein R is greater than 1.7.

3. The combustor of claim 1, wherein the NOx emission is determined by,
$$NOx \sim fcn ( \frac{1}{R } , K )$$
where κ is a computed inverse of the global strain rate

4. The combustor of claim 3, wherein a number of jets (nⱼ) in the plurality of jets is determined by,
$$R = \frac{{Re}_{J}}{{Re}_{L}} = {α [ \frac{{V}_{J}}{{V}_{L}} ]}^{1 / 2} ( \frac{1}{\sqrt{{n}_{J}}} ) = β \frac{d L}{d J} ( \frac{1}{{n}_{J}} )$$
where R is the ratio of the Reynolds number of a jet of the plurality of jets (Reⱼ) to the Reynolds number of the combustion liner (Re_{L}), Vⱼ is equal to a velocity of a jet of the plurality of jets and V_{L} is equal to a velocity of the combustion liner.

5. The combustor of claim 3, wherein a jet diameter (dⱼ) of each of the plurality of jets is sized to lower NOx emissions by increasing turbulent mixing in a flame zone.

6. The combustor of claim 5, wherein a jet diameter (dj) of each of the plurality of jets is determined by
$${d}_{J} = {[ \frac{4 \dot{m}}{πρ ( {P}_{3} , {T}_{3} ) {V}_{J} {n}_{J}} ]}^{1 / 2}$$
where m=unburned combined reactant mass flow rates of fuel and oxidizer, P3=an unburned reactant pressure, T3=one of an unburned reactant temperature or an air reheat temperature.

7. The combustor of claim 6, wherein a diameter of the combustion liner (d_{L}) is determined by
$${d}_{L} = {[ \frac{4 \dot{m}}{πρ ( {P}_{4} , {T}_{FLAME} ) {V}_{L}} ]}^{1 / 2}$$
where m=unburned combined reactant mass flow rates of fuel and oxidizer, and T_{flame}=the flame temperature.

8. The combustor of claim 7, wherein
$$R = \frac{{Re}_{J}}{{Re}_{L}} = \frac{ρ ( {P}_{3} , {T}_{3} ) {V}_{J} {d}_{J} / μ ( {T}_{3} )}{ρ ( {P}_{4} , {T}_{FLAME} ) {V}_{L} {d}_{L} / μ ( {T}_{FLAME} )}$$

9. The combustor of claim 8, wherein the inverse of the global strain rate is determined by
$$K ( s ) = \frac{1000 {d}_{J}}{{V}_{J}}$$

10. A gas turbine, comprising:
an air compressor;
a combustor coupled to the compressor, the combustor comprising:
a combustion housing; and
a combustion nozzle disposed within the combustion housing, the combustion nozzle comprising:
a mixing section comprising an air inlet, and a fuel inlet; and
an exit section comprising a plurality of jets on an exit surface; and
a combustion zone, including a combustion liner, disposed downstream and in fluidic communication with the combustion nozzle; and
a turbine coupled to the combustor,
wherein a NOx emission of the combustor is related to 1/R, where R is a Reynolds number ratio of each of the plurality of jets to the combustion liner.

11. The gas turbine of claim 10, where R is greater than 1.7.

12. The gas turbine of claim 10, wherein the NOx emission is determined by
$$NOx \sim fcn ( \frac{1}{R } , K )$$
where κ is a computed inverse of the global strain rate.

13. The gas turbine of claim 12, wherein a number of jets (nⱼ) in the plurality of jets is determined by
$$R = \frac{{Re}_{J}}{{Re}_{L}} = {α [ \frac{{V}_{J}}{{V}_{L}} ]}^{1 / 2} ( \frac{1}{\sqrt{{n}_{J}}} ) = β \frac{d L}{d J} ( \frac{1}{{n}_{J}} )$$
where R is the ratio of the Reynolds number of each of the jets of the plurality of jets (Reⱼ) to the Reynolds number of the combustion liner (Re_{L}), Vⱼ is equal to a velocity of each of the jets of the plurality of jets and V_{L} is equal to a velocity of the combustion liner.

14. The gas turbine of claim 13, wherein a jet diameter (dⱼ) of each of the plurality of jets is sized to lower NOx emissions by increasing turbulent mixing in a flame zone.

15. The gas turbine of claim 14, wherein a jet diameter (dj) of each of the plurality of jets is determined by
$${d}_{J} = {[ \frac{4 \dot{m}}{πρ ( {P}_{3} , {T}_{3} ) {V}_{J} {n}_{J}} ]}^{1 / 2}$$
where m=unburned combined reactant mass flow rates of fuel and oxidizer, P3=an unburned reactant pressure, T3=one of an unburned reactant temperature or an air reheat temperature.

16. The gas turbine of claim 15, wherein a diameter of the combustion liner diameter (d_{L}) is determined by
$${d}_{L} = {[ \frac{4 \dot{m}}{πρ ( {P}_{4} , {T}_{FLAME} ) {V}_{L}} ]}^{1 / 2}$$
where m=unburned combined reactant mass flow rates of fuel and oxidizer, and T_{flame} is the flame temperature in the combustion zone.

17. The gas turbine of claim 16, wherein
$$R = \frac{{Re}_{J}}{{Re}_{L}} = \frac{ρ ( {P}_{3} , {T}_{3} ) {V}_{J} {d}_{J} / μ ( {T}_{3} )}{ρ ( {P}_{4} , {T}_{FLAME} ) {V}_{L} {d}_{L} / μ ( {T}_{FLAME} )}$$

18. A method for achieving NOx reduction in a combustion nozzle including a plurality of jets at an exit surface comprising:
setting a combustion liner velocity (V_{L}) based on machine sizing requirements;
setting a combustion liner diameter (d_{L}) based on machine sizing requirements;
selecting one of a jet velocity (V_{J}) or a jet diameter (d_{J}) based on desired pressure drop across an exit surface of the combustion nozzle;
calculating the number of jets (n) at the exit surface of the combustion nozzle;
calculating the other of a jet diameter (dⱼ) or a jet velocity (V_{J}) of each jet at the exit surface of the combustion nozzle; and
calculating an inverse of the global strain rate to determine if k criteria is achieved.

19. The method of claim 18, wherein the step of calculating the number of jets (n) at the exit surface of the combustion nozzle is determined by,
$$R = \frac{{Re}_{J}}{{Re}_{L}} = {α [ \frac{{V}_{J}}{{V}_{L}} ]}^{1 / 2} ( \frac{1}{\sqrt{{n}_{J}}} ) = β \frac{d L}{d J} ( \frac{1}{{n}_{J}} )$$
where R is the ratio of the Reynolds number of each of the jets of the plurality of jets (Reⱼ) to the Reynolds number of a combustion liner (Re_{L}), Vⱼ is equal to a velocity of each of the jets of the plurality of jets and V_{L} is equal to a velocity of the combustion liner.

20. The method of claim 19, wherein the step of calculating a jet diameter (dⱼ) at the exit surface of the combustion nozzle is determined by,
$${d}_{J} = {[ \frac{4 \dot{m}}{πρ ( {P}_{3} , {T}_{3} ) {V}_{J} {n}_{J}} ]}^{1 / 2}$$
where m=unburned combined reactant mass flow rates of fuel and oxidizer, P3=an unburned reactant pressure, T3=one of an unburned reactant temperature or an air reheat temperature.
